(19) United States
(12) Patent Application Publication
(10) Pub. No.: US 2006/0232550 A1
(43) Pub. Date: Oct. 19, 2006

(54) Integrated mouse in remote control

(76) Inventor: Nathan C. Buckner, Round Rock, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/107,374

(22) Filed: Apr. 15, 2005

(51) Int. Cl. G09G 5/00

(52) U.S. Cl. 345/156

(57) ABSTRACT

In various embodiments, a remote control may include a mouse logic functionality on the remote control such that when the remote control is placed on a surface, the movements of the remote control are translated into movements for a movement functionality (e.g., moving an on screen cursor) on a system such as a video conferencing system. In some embodiments, when the remote control is picked up, the mouse logic functionality may be discontinued. In some embodiments, the mouse logic functionality may continue to work after the remote control is picked up.

### BACKGROUND OF THE INVENTION

1. Field of the Invention

The present invention relates generally to control devices and, more specifically, to remote controls.

2. Description of the Related Art

Remote controls may be useful for controlling devices such as televisions and garage doors. Remote controls may transmit commands to a device through infrared signals. Remote controls may use other signals. For example, the remote control may be connected by a wire to the device and may send commands along the wire.

A computer mouse may send signals to a computer to control, for example, a cursor on the computer screen. The movement of the mouse is detected by a sensor on the mouse (e.g., a trackball or optical sensor). While there are devices that interface with a remote control and a mouse, the remote control and mouse are separate devices.

### SUMMARY OF THE INVENTION

In various embodiments, a remote control may include a mouse logic functionality on the remote control such that when the remote control is placed on a surface, the movements of the remote control are translated into movements for a movement functionality (e.g., moving an on-screen cursor) on a system such as a video conferencing system. In some embodiments, when the remote control is placed on a surface, such as a conference table, a button on the bottom of the remote control may be depressed. In some embodiments, the button may be a spring type or capacitor type. Other buttons are also contemplated. In addition, other sensors for detecting when the mouse has been placed on a surface may also be used. In some embodiments, the depressed button may activate a mouse logic functionality on the remote control. In some embodiments, a sensor on the bottom of the remote control may detect movement of the remote control on the surface (e.g., a trackball or optical sensor), and the movements may be translated to the system to control a functionality such as an on-screen cursor. In some embodiments, when the mouse is picked up, the button may return to its original position (or the sensor may detect the remote control has been lifted from the surface). The mouse logic functionality may then no longer be considered by the system (e.g., the mouse logic functionality may be deactivated or the signals from the mouse logic functionality may be ignored). In some embodiments, the mouse logic functionality may continue to work even after the remote control is picked up.

### BRIEF DESCRIPTION OF THE DRAWINGS

A better understanding of the present invention may be obtained when the following detailed description is considered in conjunction with the following drawings, in which:

FIG. 1 illustrates a video conferencing system, according to an embodiment;

FIG. 2 illustrates a front view of a remote control, according to an embodiment;

FIG. 3 illustrates a side view of the remote control, according to an embodiment;

FIG. 4 illustrates a bottom view of the remote control, according to an embodiment; and

FIG. 5 illustrates a method for using a remote control with a mouse feature, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

Incorporation by Reference

U.S. Provisional Patent Application Ser. No. 60/619,303, titled “Speakerphone”, which was filed Oct. 15, 2004, whose inventors are Michael L. Kenoyer, William V. Oxford, and Simon Dudley is hereby incorporated by reference in its entirety as though fully and completely set forth herein.

U.S. Provisional Patent Application Ser. No. 60/619,212, titled “Video Conferencing Speakerphone”, which was filed Oct. 15, 2004, whose inventors are Michael L. Kenoyer, Craig B. Malloy, and Wayne E. Mock is hereby incorporated by reference in its entirety as though fully and completely set forth herein.

U.S. Provisional Patent Application, serial number 60/619,210, titled “Video Conference Call System”, which was filed Oct. 15, 2004, whose inventors are Michael J. Burkett, Ashish Goyal, Michael V. Jenkins, Michael L. Kenoyer, Craig B. Malloy, and Jonathan W. Tracey is hereby incorporated by reference in its entirety as though fully and completely set forth herein.

U.S. Provisional Patent Application, serial number 60/619,227, titled “High Definition Camera and Mount”, which was filed Oct. 15, 2004, whose inventors are Michael L. Kenoyer, Patrick D. Vanderwilt, Paul D. Frey, Paul Leslie Howard, Jonathan I. Kaplan, and Branko Lukic, is hereby incorporated by reference in its entirety as though fully and completely set forth herein.

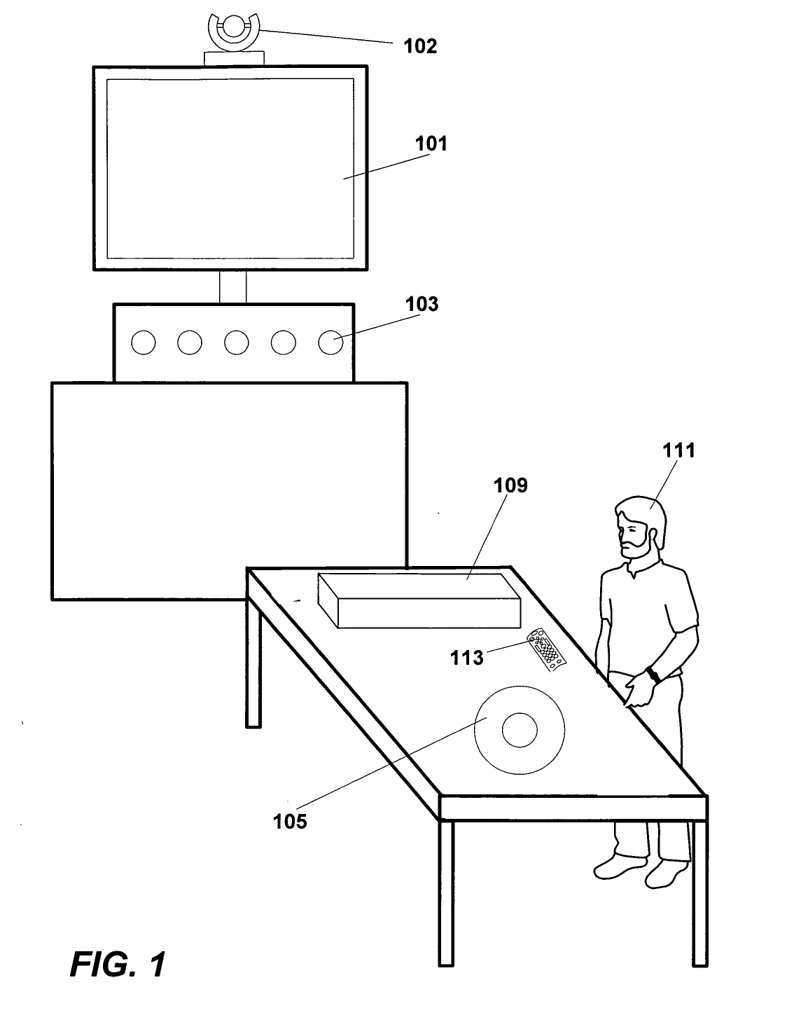

FIG. 1 illustrates a video conferencing system, according to an embodiment. In some embodiments, a remote control device 113 may be used with a system such as a video conferencing system. However, embodiments of the device 113 described herein may be used with any of various types of systems, and the video conferencing system is exemplary only. For example, the remote control device 113 may be used in conjunction with television systems, audio systems, computer systems, presentation systems, etc.

The remote control device 113 may include functionality for enabling a user to remotely control a system, e.g., to control a system remotely using wireless communication. The term “remote control” is intended to have the full breadth of its ordinary meaning. For example, the remote control device 113 may have a user interface, such as buttons, etc., which the user may operate, thereby causing wireless signals to be transmitted to control a system. As another example, the remote control device may be remotely located from the system it controls and may couple to the system in a wired manner for transmission of signals to control the system.

The remote control device 113 may also include pointing device functionality, also called “mouse” functionality. The term “mouse” functionality is intended to have the full breadth of its ordinary meaning. For example, the terms “pointing device” or “mouse” functionality refer to functionality whereby the device may be moved on a surface, such as a table, and this movement is detected and used to control an on-screen graphical user interface, e.g., to control the position of a cursor on the GUI.

In some embodiments, the video conferencing system may include a camera 102, a display 101, a sound system 103, a speakerphone 105, and a codec 109. Other components are also contemplated. The remote control 113 may interface with one or more of these components through a wireless means (e.g., through an infrared or radio frequency (RF) connection). In some embodiments, the remote control 113 may interface through a physical interface (e.g., a wire).

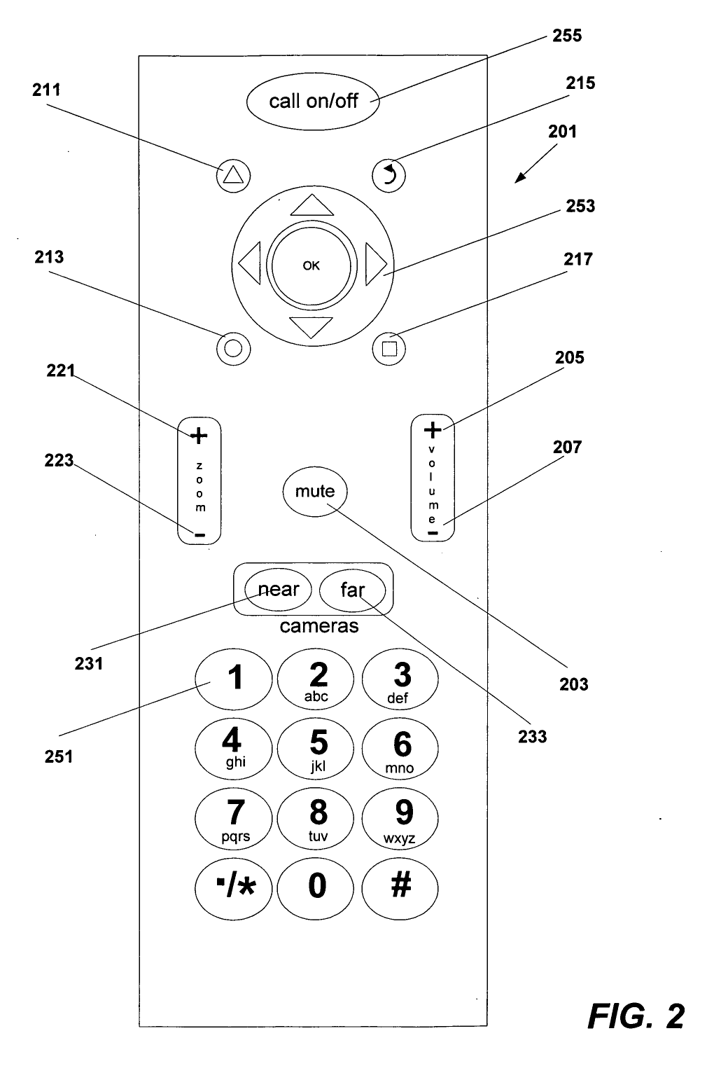

FIG. 2 illustrates a front view of a remote control, according to an embodiment. In some embodiments, the remote control may include buttons and/or other sensors for receiving user inputs to the system. For example, the remote control 113 may include a volume up portion 205 and down portion 207 of a button(s) to control the volume of a sound system 103 and/or speakerphone 105 coupled to the video conferencing system. The remote control 113 may also include a mute button 203. In some embodiments, the remote control 113 may include a zoom in portion 221 and zoom out portion 223 of a button(s) to control the camera 102 and/or display 101. In some embodiments, if the video conferencing system has multiple cameras, the near button 231 and far buttons 233 may be used to designate the camera currently being controlled. Other function buttons 211, 213, 215, and 217 may be used alone or in conjunction with other buttons (e.g., the pointer button 253) to control functions of the video conferencing system. The remote control 113 may include numerical keys 251 to use with the video conferencing system (e.g., to dial a call). A call on/off button 255 may be used to initiate and terminate calls. Other functions for the call on/off button 255 are also contemplated.

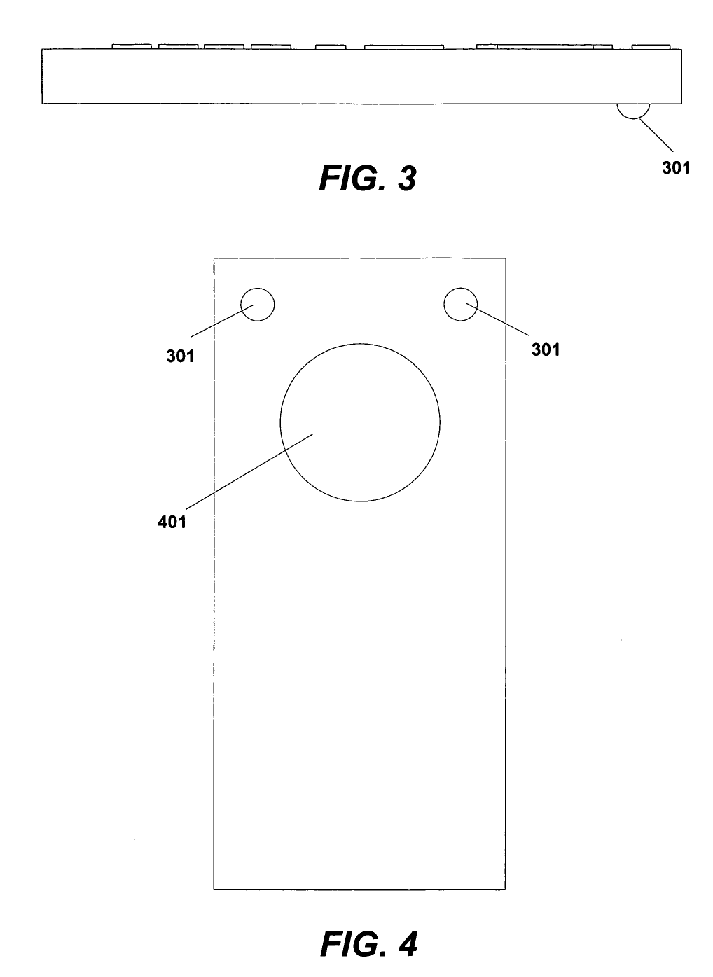

FIG. 3 illustrates a side view of the remote control, according to an embodiment. In some embodiments, the remote control 113 may include a position detector such as a button 301 (or other sensor) on the bottom of the remote control 113 to trigger (i.e., turn on/off) a point device or mouse feature on the remote control 113. For example, when the remote control 113 is placed on a table, the weight of the remote control 113 may depress button 301, turning on the mouse feature. In some embodiments, when the remote control 113 is lifted from the table, the button 301 may return to its original position, turning off the mouse feature.

FIG. 4 illustrates a bottom view of the remote control, according to an embodiment. A mouse feature may be supported by mouse component 401. The mouse component may be a sensor (e.g., a track ball or optical mouse sensor). As the remote control is moved on the table, the mouse component 401 may detect movement and may transfer the movement as signals to the video conferencing system. The video conferencing system may interpret the movements relative to an implemented functionality such as a cursor on the screen. In some embodiments, the movements may be translated to a cursor on the screen, position a camera, or electrically draw on the image on the screen (e.g., telestrating). In some embodiments, the on screen cursor may select options on an on-screen menu. In some embodiments, the movements may be translated to control a virtual pen to edit an image on the display. In some embodiments, the movements may be translated to control functions (e.g., volume) where analog control may be preferred.

While some embodiments may include a remote control with a mouse feature being used with video conferencing systems, it is to be understood that the remote control may be used with other systems. Also, additional embodiments of the remote control may include different form factors, different buttons, and different functionalities implemented by the different buttons.

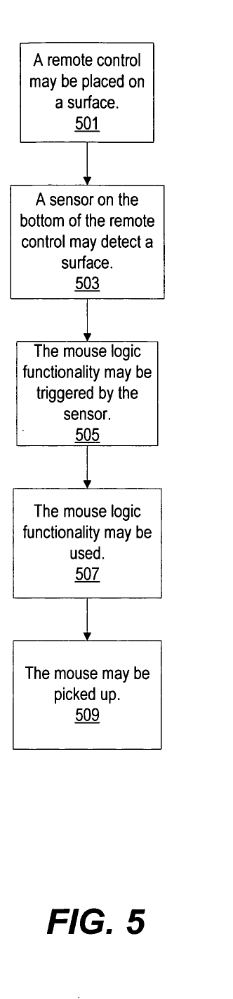

FIG. 5 illustrates a method for using a remote control with a mouse feature, according to an embodiment. It should be noted that in various embodiments of the methods described below, one or more of the elements described may be performed concurrently, in a different order than shown, or may be omitted entirely. Other additional elements may also be performed as desired.

At 501, a remote control 113 may be placed on a surface. In some embodiments, the remote control may be placed on a conference table or other hard surface. Other surfaces may also be used.

At 503, a sensor (e.g., a button) on the bottom of the remote control may detect a surface (e.g., the button may be depressed). In some embodiments, the button may be a spring type or capacitor type. Other buttons and/or sensors are also contemplated. In some embodiments, the depressed button may activate a mouse logic functionality on the remote control.

At 505, the mouse logic functionality may be triggered by the sensor. In some embodiments, a sensor on the bottom of the remote control may detect movement of the remote control.

At 507, the mouse logic functionality may be used. In some embodiments, the movements may be translated to the video conferencing system to control a functionality such as an on-screen cursor.

At 509, the mouse may be picked up. In some embodiments, the button may return to its original position. The mouse logic functionality may no longer be considered by the video conferencing system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An apparatus, comprising:
a housing, wherein the housing is sized to be held by a user;
remote control logic comprised in the housing, wherein the remote control logic enables the apparatus to operate as a remote control device for remotely controlling a system;
a sensor which is operable to detect whether the housing is positioned on a surface; and
mouse logic functionality coupled to the remote control, wherein the mouse logic functionality is triggered by the position detector detecting that the housing is positioned on a surface.

2. The apparatus of claim 1, wherein the mouse logic functionality uses the sensor in determining a position of the mouse.

3. The apparatus of claim 1, wherein the remote control is configured to communicate with a video conferencing system and a speakerphone.

4. The apparatus of claim 1, wherein the remote control comprises at least one volume button and at least one zoom button.

5. The apparatus of claim 1, wherein the mouse logic functionality is configured to control a cursor on a system when triggered by the sensor.

6. The apparatus of claim 1, wherein the sensor comprises an optical sensor.

7. The apparatus of claim 1, wherein the sensor comprises a button.

8. An apparatus for interfacing with a video conferencing system, comprising:
a remote control;
a position detector coupled to the remote control; and
a mouse logic functionality coupled to the remote control, wherein the mouse logic functionality is triggered by the position detector.

9. The apparatus of claim 8, wherein the remote control is configured to communicate with a video conferencing system and a speakerphone.

10. The apparatus of claim 8, wherein the remote control comprises at least one volume button and at least one zoom button.

11. The apparatus of claim 8, wherein the mouse logic functionality is configured to control a cursor on a system when triggered by the position detector.

12. The apparatus of claim 8, wherein the position detector comprises an optical sensor.

13. The apparatus of claim 8, wherein the position detector comprises a button.

14. A method, comprising:
placing a remote control on a surface;
detecting the surface through a sensor on the remote control;
triggering a mouse logic functionality on the remote control; and
using the mouse logic functionality.

15. The method of claim 14, further comprising:
picking up the remote control; and
deactivating the mouse logic functionality.

16. The method of claim 14, wherein the remote control is configured to communicate with a video conferencing system and a speakerphone.

17. The method of claim 14, wherein the remote control comprises at least one volume button and at least one zoom button.

18. The method of claim 14, wherein using the mouse logic functionality comprises controling a cursor on a system.

19. The method of claim 14, wherein the sensor comprises an optical sensor.

20. The method of claim 14, wherein the sensor comprises a button.
